(19) United States
(12) Patent Application Publication
(10) Pub. No.: US 2019/0337451 A1
(43) Pub. Date: Nov. 7, 2019

(54) REMOTE VEHICLE SPATIAL AWARENESS NOTIFICATION SYSTEM

(71) Applicant: GM Global Technology Operations LLC, Detroit, MI (US)

(72) Inventors: Brent N. Bacchus, Sterling Heights, MI (US); Lawrence A. Bush, Shelby Township, MI (US); Shifang Li, Shelby Township, MI (US); Evripidis Paraskevas, Royal Oak, MI (US); Prakash Mohan Peranandam, Troy, MI (US); Yuchen Zhou, Troy, MI (US)

(21) Appl. No.: 15/969,292

(22) Filed: May 2, 2018

(51) Int. Cl. B60Q 9/00

(52) U.S. Cl. CPC B60Q 9/008

(57) ABSTRACT

Technical solutions are described herein for providing driver notification in a vehicle. An example system includes one or more sensors that measure one or more attributes of a remote object in a predetermined vicinity of the vehicle. The system further includes an output device that provides a notification to a driver. The system further includes a remote object monitoring system that generates a driver notification to be provided via the output device based on the attributes of the remote object. Generating the driver notification includes determining a recklessness score for the remote object based on the attributes of the remote object. Generating the driver notification further includes, in response to the recklessness score exceeding a predetermined threshold, generating the driver notification that comprises a directional information that provides a spatial awareness of a location of the remote object in relation to the vehicle.

### INTRODUCTION

The present disclosure relates to haptic devices, and more particularly to haptic seats in a vehicle to provide continuous feedback and dynamic alerts to a driver.

It is desirable to provide continuous feedback and/or dynamic alerts to a driver of vehicle to warn the driver of one or more system prioritized events around the vehicle that can be automatically detected by one or more sensors or other systems of the vehicle to a avoid collision and improve safety of the vehicle. Along with audio and visual alerts, it is desirable to provide alerts using a haptic device. Other desirable features and characteristics will become apparent from the subsequent detailed description and the appended claims, taken in conjunction with the accompanying drawings and the foregoing technical field and background.

### SUMMARY

Technical solutions are described herein for providing driver notification in a vehicle. An example system includes one or more sensors that measure one or more attributes of a remote object in a predetermined vicinity of the vehicle. The system further includes an output device that provides a notification to a driver. The system further includes a remote object monitoring system that generates a driver notification to be provided via the output device based on the attributes of the remote object. Generating the driver notification includes determining a recklessness score for the remote object based on the attributes of the remote object. Generating the driver notification further includes, in response to the recklessness score exceeding a predetermined threshold, generating the driver notification that comprises a directional information that provides a spatial awareness of a location of the remote object in relation to the vehicle.

In one or more examples, the remote object is prioritized from a plurality of remote objects. In one or more examples, the driver notification is an augmented reality notification comprising a haptic notification, a visual notification, and an audible notification, and wherein the haptic notification provides the directional information using haptic actuators from a specific section of a haptic alert device. Further, the visual notification changes a color of the remote object in response to the recklessness score exceeding the predetermined threshold. Alternatively, or in addition, the audible notification provides the directional information using speakers from a specific section.

In one or more examples, determining the recklessness score includes receiving a prior recklessness score of the remote object based on an identification of the remote object, and updating the prior recklessness score using the attributes of the remote object received from the one or more sensors. In one or more examples, storing the updated recklessness score for the remote object to be accessed by a second vehicle.

The attributes of the remote object include a lateral variability of the remote object that is determined based on a deviation of the remote object within a lane of a road along which the remote object is traveling. The attributes of the remote object include abrupt braking by the remote object that is determined based on a maximum deceleration of the remote object within a predetermined time window. The attributes of the remote object include a number of lane changes by the remote object within a predetermined time window. The attributes of the remote object include a tailgating distance determined for the remote object with respect to a second remote object. The attributes of the remote object include a number of traffic sign violations by the remote object within a predetermined window.

According to one or more embodiments, a method for providing driver notification in a vehicle includes measuring, by one or more sensors, attributes of a remote object in a predetermined vicinity of the vehicle. The method further includes determining, by a controller, a recklessness score for the remote object based on the attributes of the remote object. The method further includes, in response to the recklessness score exceeding a predetermined threshold, generating, by the controller, the driver notification that comprises a directional information that provides a spatial awareness of a location of the remote object in relation to the vehicle. The method further includes providing, by an output device, the notification to a driver.

In one or more examples, the remote object is prioritized from a plurality of remote objects. In one or more examples, the driver notification is an augmented reality notification comprising a haptic notification, a visual notification, and an audible notification, and wherein the haptic notification provides the directional information using haptic actuators from a specific section of a haptic alert device. Further, the visual notification changes a color of the remote object in response to the recklessness score exceeding the predetermined threshold. Alternatively, or in addition, the audible notification provides the directional information using speakers from a specific section.

In one or more examples, determining the recklessness score includes receiving a prior recklessness score of the remote object based on an identification of the remote object, and updating the prior recklessness score using the attributes of the remote object received from the one or more sensors. In one or more examples, storing the updated recklessness score for the remote object to be accessed by a second vehicle.

The attributes of the remote object include a lateral variability of the remote object that is determined based on a deviation of the remote object within a lane of a road along which the remote object is traveling. The attributes of the remote object include abrupt braking by the remote object that is determined based on a maximum deceleration of the remote object within a predetermined time window. The attributes of the remote object include a number of lane changes by the remote object within a predetermined time window. The attributes of the remote object include a tailgating distance determined for the remote object with respect to a second remote object. The attributes of the remote object include a number of traffic sign violations by the remote object within a predetermined window.

According to one or more embodiments, a computer program product comprising computer storage device having computer executable instructions stored therein, the computer executable instructions when executed by a processing unit cause the processing unit to provide a driver notification in a vehicle. Providing the driver notification includes determining, by a controller, a recklessness score for the remote object based on the attributes of the remote object. Providing the driver notification further includes, in response to the recklessness score exceeding a predetermined threshold, generating, by the controller, the driver notification that comprises a directional information that provides a spatial awareness of a location of the remote object in relation to the vehicle. Providing the driver notification further includes providing, by an output device, the notification to a driver.

In one or more examples, the remote object is prioritized from a plurality of remote objects. In one or more examples, the driver notification is an augmented reality notification comprising a haptic notification, a visual notification, and an audible notification, and wherein the haptic notification provides the directional information using haptic actuators from a specific section of a haptic alert device. Further, the visual notification changes a color of the remote object in response to the recklessness score exceeding the predetermined threshold. Alternatively, or in addition, the audible notification provides the directional information using speakers from a specific section.

In one or more examples, determining the recklessness score includes receiving a prior recklessness score of the remote object based on an identification of the remote object, and updating the prior recklessness score using the attributes of the remote object received from the one or more sensors. In one or more examples, storing the updated recklessness score for the remote object to be accessed by a second vehicle.

The attributes of the remote object include a lateral variability of the remote object that is determined based on a deviation of the remote object within a lane of a road along which the remote object is traveling. The attributes of the remote object include abrupt braking by the remote object that is determined based on a maximum deceleration of the remote object within a predetermined time window. The attributes of the remote object include a number of lane changes by the remote object within a predetermined time window. The attributes of the remote object include a tailgating distance determined for the remote object with respect to a second remote object. The attributes of the remote object include a number of traffic sign violations by the remote object within a predetermined window.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 depicts a block diagram of a vehicle that includes a driver alert system 100 in accordance with exemplary embodiments;

FIG. 2 depicts a schematic side view of a vehicle seat assembly in accordance with an exemplary embodiment;

FIG. 3 is a top view of the seat assembly in accordance with an exemplary embodiment;

FIG. 4 depicts a front view of the seat assembly in accordance with an exemplary embodiment;

FIG. 5 depicts an example seat assembly with multiple haptic actuators that are part of the haptic alert system, which are configured and calibrated based on a user footprint;

FIG. 6 depicts a block diagram of a haptic alert device customization system according to one or more embodiments;

FIG. 7 depicts a flowchart for customizing a haptic alert device according to one or more embodiments;

FIG. 8 depicts a block diagram for an augmented reality system for a vehicle according to one or more embodiments;

FIG. 9 depicts a flowchart for providing spatial awareness alerts to a driver via an augmented reality system according to one or more embodiments;

FIG. 10 depicts an operational flow diagram for a method for monitoring a remote vehicle and determining the recklessness score for the remote vehicle; and

FIG. 11 depicts an example driving scenario according to one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory module that executes one or more software or firmware programs, a combinational logic circuit, and/or other suitable components that provide the described functionality.

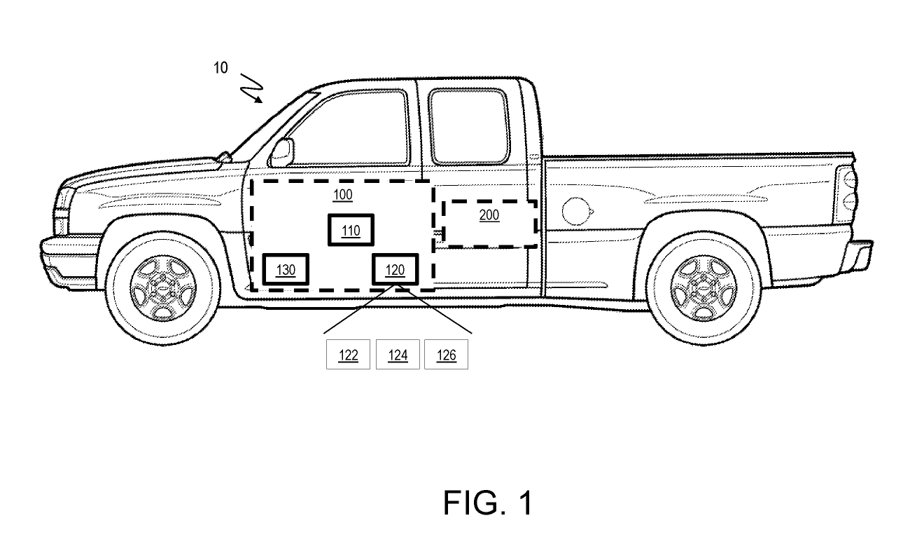

FIG. 1 depicts a block diagram of a vehicle 10 that includes a driver alert system 100 in accordance with exemplary embodiments. The driver alert system 100 includes, among other components, a collision avoidance module (or sub-systems) 110, a haptic alert device (or haptic feedback device) 120, and a control module 130. In one or more examples, the driver alert system 100 can further include, a communications module, and one or more additional alert devices, such as a visual alert device, an auditory alert device, and an infotainment alert device. In one or more examples, the haptic alert device 120 may be incorporated into a vehicle seat assembly 200.

During operation, and as also discussed in greater detail herein, the control module 130 receives input signals from the collision avoidance module 110. The control module 130 evaluates the input signals and, as appropriate, operates the haptic alert device 120 and/or other alert devices to alert the driver based on the condition indicated by the received input signals. For example, the driver alert system 100 may function to alert the driver of a collision condition such that avoidance maneuvers (e.g., braking and/or steering) and/or automatic crash mitigation responses (e.g., braking and/or steering) may be initiated. Alternatively, or in addition, the driver alert system 100 alerts the driver of a remote vehicle based on one or more safety characteristics of the remote vehicle being monitored. Alternatively, or in addition, the driver alert system 100 provides the driver of spatial awareness regarding one or more objects in the vicinity of the vehicle 10. Although the figures shown herein depict example arrangements of elements, additional intervening elements, devices, features, or components may be present in an actual embodiment.

The collision avoidance module 110 can include one or more on-board vehicle sensors (e.g., camera, radar, ultrasonic, and/or lidar) that detect a potential for a collision based on the vehicle sensor signals. The collision avoidance module 110 may generally be implemented as, for example, forward collision warning systems, lane departure warning systems, lane keeping assist systems, front park assist systems, rear park assist systems, front and rear automatic braking systems, rear cross traffic alert systems, adaptive cruise control (ACC) systems, side blind spot detection systems, lane change alert systems, driver attention systems, front pedestrian detection systems, and rear pedestrian detection systems. As noted herein, the driver alert system 100 may further include a communications module to enable communications between vehicles and/or between the vehicle and an infrastructure to forecast a potential collision due to traffic or activity either inside the line-of-sight of the driver or outside of the line-of-sight of the driver (e.g., a road hazard or traffic jam ahead is detected beyond the driver's line-of-sight). In one or more examples, the collision avoidance module 110 and/or communications module are communicatively coupled to the control module 130 that evaluates a potential for a collision based on the vehicle sensor signals and/or communications.

The haptic alert device 120 includes one or more submodules or units 122, 124, and 126, which cooperate to calibrate and generate an alert for the driver. The haptic alert device 120 may include a monitoring unit 122, a user customization unit 124, and an identification unit 126. As can be appreciated, the units shown in FIG. 1 may be combined and/or further partitioned to similarly coordinate and provide driver alerts.

The monitoring unit 122 monitors one or more components of the vehicle 10 to determine if a component is malfunctioning, the monitoring unit 122 may generate a warning message, a warning signal, and/or a faulty condition status that may be communicated to the vehicle driver or technician.

The user customization unit 124 manages the display of a configuration menu and manages user input received from a user interacting with the configuration menu. Such a configuration menu may be displayed on a display device within the vehicle 10 (for example, on an infotainment system display) or a display device remote from the vehicle 10. In various embodiments, the configuration menu includes selectable options that, when selected, allow a user to configure the various alert settings associated with the haptic alert device 120, and/or the other alert devices. The alert settings for the haptic alert assembly 120 can include, but are not limited to, an occurrence of the vibration (e.g., whether or not to perform the vibration for a particular mode), a location of the vibration on the seat, an intensity of the vibration, a duration of the vibration, and/or a frequency of the pulses of the vibration. Based on the user input received from the user interacting with the configuration menu, the user customization unit 124 stores the user configured alert settings in an alert settings database. As can be appreciated, the alert settings database may include volatile memory that temporarily stores the settings, non-volatile memory that stores the settings across key cycles, or a combination of volatile and non-volatile memory.

In one or more examples, the user configured alert settings are stored specific to different users, for example, by associating the user configured alert settings with a user identifier. The identification unit 126 automatically identifies the driver based on the user identification and sends a control signal to the user customization unit 124 to adjust the user settings of the haptic alert device 120 accordingly. The user identifier can be user login information, such as a username/password combination, biometric information of the user (fingerprint, iris, face etc.), or an electronic device carried by the user (key fob, RFID card etc.). The user customization unit 124 identifies the user that is the ‘driver’ of the vehicle 10 based on the user identification and adjusts the settings of the haptic alert device 120 using the user configured alert settings of the identified user.

Alternatively, or in addition, if the identification unit 126 cannot identify the driver, for example in case of a new user, or if the driver does not have settings that are stored, the identification unit 126 estimates the user's weight and footprint automatically using one or more haptic actuators of the haptic alert device 120. The identification unit 126, based on the estimated weight and footprint automatically generates user settings that are sent to the user customization unit 124 for adjusting the settings accordingly.

Further, the identification unit 126 adapts a subset of active actuators over time for each driver for dynamic reconfiguration. For example, the user settings associated with a first user are updated by the identification unit 126, automatically and dynamically, during operation of the vehicle 10. The automatic recalibration may be performed based on the user's posture, user's movement, feedback from the haptic actuators in the seat assembly 200, and the like.

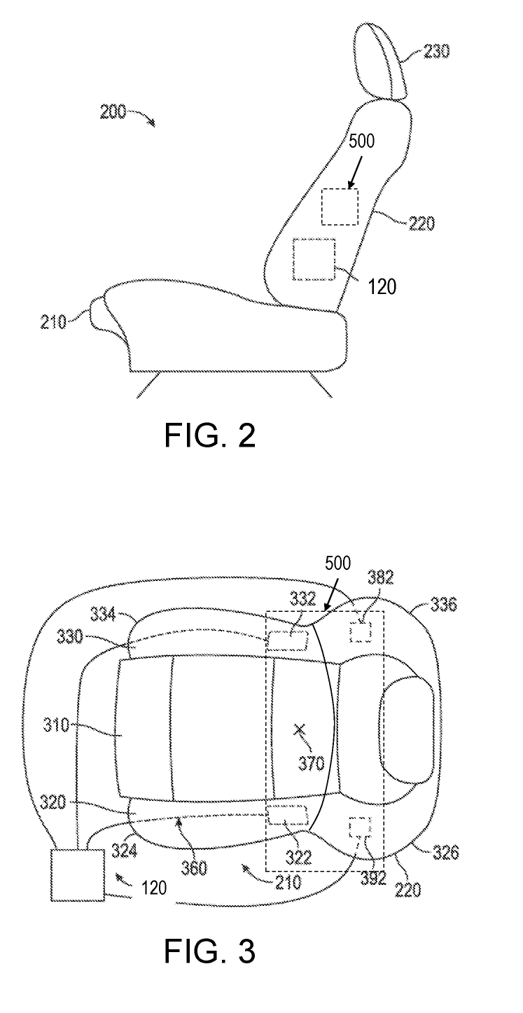

FIG. 2 depicts a schematic side view of a vehicle seat assembly 200 in accordance with an exemplary embodiment. The seat assembly 200 may be installed on a floor of the passenger area of the vehicle 10. The seat assembly 200 is a driver seat for an automobile, although in other exemplary embodiments, the seat assembly 200 may be a passenger seat and/or implemented into any type of vehicle. Although an exemplary seat assembly 200 is described below, the driver alert system 100 may be implemented in any suitable type of seat assembly, including free standing seats, bench seats, massage seats, and the like.

The seat assembly 200 includes a lower seat member 210, a seat back member 220, a head rest 230, and the haptic alert device 120. The lower seat member 210 defines a generally horizontal surface for supporting an occupant (not shown). The seat back member 220 may be pivotally coupled to the lower seat member 210 and defines a generally vertical surface for supporting the back of an occupant. The head rest 230 is operatively coupled to the seat back member 220 to support the head of an occupant.

FIG. 3 is a top view of the seat assembly 200 in accordance with an exemplary embodiment. As shown in FIG. 3, the lower seat member 210 generally includes a seat pan 310, a first lower bolster 320, and a second lower bolster 330. The lower bolsters 320, 330 are generally considered the left outermost and right outermost side of the lower seat member 210, respectively. As can be appreciated, in various other embodiments, the seat pan 310 can be without lower bolsters 320, 330, such as a flat seat. In FIG. 3, the lower bolsters 320, 330 are arranged on the longitudinal sides of the seat pan 310 (e.g., the left and right sides) to support the legs and thighs of the occupants. Each of the lower bolsters 320, 330 may be considered to have a front end 324, 334 and a back end 326, 336 relative to the primary direction of travel. As shown, the seat back member 220 may overlap a portion of the lower bolsters 320, 330 at the back ends 326, 336. As is generally recognized in seat design, the lower bolsters 320, 330 are arranged on the sides of the lower seat member 210, typically at an angle to the seat pan 310. The haptic alert device 120 is integrated with the seat assembly 200 be being connected with an array of actuators 500, that includes haptic actuators 322, 332, 362, and 392.

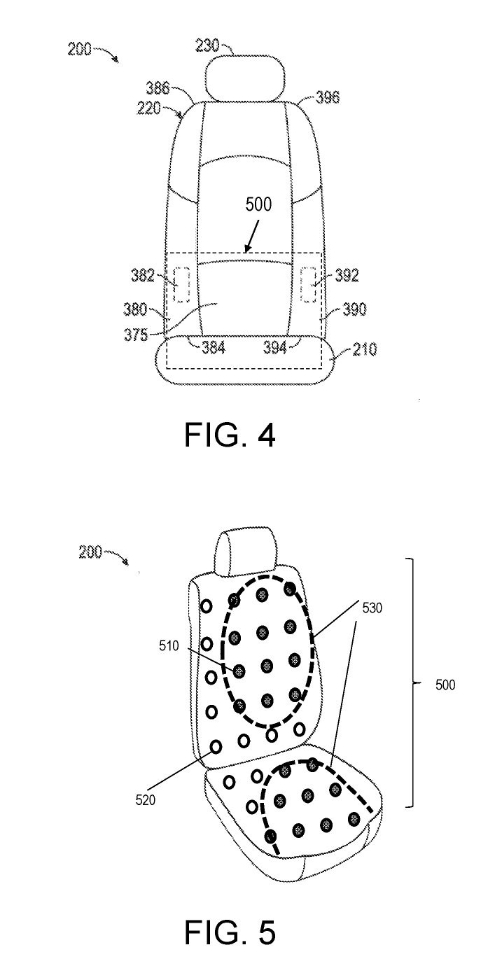

FIG. 4 depicts a front view of the seat assembly 200 in accordance with an exemplary embodiment. The seat back member 220 includes a main seat back portion 375, a first back bolster 380, and a second back bolster 390, although other arrangements may be possible. The back bolsters 380, 390 are arranged on the longitudinal sides of the main seat back portion 375 (e.g., the left and right sides) to support the sides of the back of the occupant. Each of the back bolsters 380, 390 may have a bottom end 384, 394 and a top end 386, 396 relative to the general orientation of the seat assembly 200.

The haptic alert device 120 is shown to be integrated with the illustrated the seat assembly 200. For example, the haptic alert device 120 includes an array of actuators 500, which includes a first actuator 322 installed in the first lower bolster 320 and a second actuator 332 installed in the second lower bolster 330. The haptic alert device 120 may further include a third actuator 382 installed in the first back bolster 380 and a fourth actuator 392 installed in the second back bolster 390. It should be noted that in other embodiments, the array 500 may include any number of additional actuators on either side of the seat back member 220, as well as other locations.

FIG. 5 depicts an example seat assembly 200 with multiple haptic actuators in the array 500 that is part of the haptic alert system 120. The actuators in the array 500 are configured and calibrated based on a user footprint as described herein. The seat assembly 200 includes the haptic alert device 120, which includes an array of actuators 500 among which, a first set of actuators 510 are active and a second set of actuators 520 are inactive. The user customization unit 124 determines which actuators to activate and which ones to deactivate based on a user footprint 530. In one or more examples, the user identification unit 126 determines the user footprint 530 and the actuators to be activated/deactivated are determined based on a boundary of the footprint 530. The actuators 510 that fall within the boundary of the footprint are activated and the actuators 520 that are outside the boundary are deactivated.

The technical solutions described herein accordingly facilitate automatically adjusting arrays of haptic actuators in a seat assembly based on a user's physical profile and personal preference by dynamically reconfiguring a subset of actuators as well as determining the appropriate driving intensity of the activated actuators. It is understood that the number of actuators shown in FIG. 5, or any other drawings herein are exemplary and that in one or more embodiments, the number of actuators can be different than those illustrated herein. For explanation purposes, the description herein shall use the haptic alert device 120 with the array 500 including the actuators 322, 332, 382, and 392.

Referring to FIG. 3, the actuators 322, 332, 382, 392 are provided to independently generate the desired haptic signals to the occupant either on the left bottom side, right bottom side, left back side, right back side, and/or any combination thereof. However, in other embodiments, additional actuators may be provided in the array 500 (FIG. 5), either in the seat bottom, seat back, other parts of the seat, or in other parts of the vehicle. In one exemplary embodiment, installation of the actuators 322, 332, 382, 392 in the respective bolsters 320, 330, 380, 390 functions to isolate the actuators vibration from one another such that the actuators 322, 332, 382, 392 tactile vibration is decoupled (or isolated) from one another. As such, the vibrations may be highly localized. Consequently, when it is desired to generate only a subset of all the haptic actuators (e.g., one or two left-side actuators), the seat occupant does not experience unintended vibrations that can travel through the seat cushion material or seat structure to the other actuator location (e.g., the right-side actuator(s)). As one example, the peak amplitude of measured vertical acceleration at the activated actuator location normal to the seat bolster surface may be at least seven times greater than the peak amplitude of the measured acceleration along the axis parallel to the axis of rotation of the motor actuation.

In one or more examples, the first and second actuators 322, 332 are positioned about two-thirds of the distance between the front ends 324, 334 of the bolsters 320, 330 and the seat back member 220. In one exemplary embodiment, the first and second actuators 322, 332 (e.g., the forward edge of the actuators 322, 332) may be laterally aligned with the H-point (or hip-point) 370, as schematically shown. In other embodiments, the actuators 322, 332 (e.g., the rear edge of the actuators 322, 332) are positioned approximately 25 cm forward of the H-point 370 and/or between 0 cm and 25 cm forward of the H-point 370. As generally recognized in vehicle design, the H-point 370 is the theoretical, relative location of an occupant's hip, specifically the pivot point between the torso and upper leg portions of the body. In general and as discussed above, the actuators 322, 332 are positioned with consideration for performance, durability, and comfort. The exemplary positions discussed herein enable advantageous occupant responses from the perspectives of both faster and more accurate detection and interpretation (e.g., feeling the vibration and recognizing the alert direction), typically on the order of hundreds of milliseconds.

Determining the user footprint 530 can be part of the user identification when the user sits on the seat assembly 200, or when the vehicle 10 is started, or in response to any other such event that initiates the user identification. Activating and deactivating the actuators is referred to herein as “configuring” the actuators in the haptic alert device 120. Further, the user customization unit 124 also “calibrates” the actuators, which includes adjusting an intensity of the actuators, which in turn adjusts an amount of vibration, or haptic feedback provided by each of the actuators to the driver. Determining the calibration of the actuators can be limited to only the activated actuators 510, in one or more examples. Further, calibrating the actuators, in one or more examples, is specific to the identified user. For example, the intensity of an actuator will depend on user settings and demographics (e.g., low for heavy individuals.). The user customization unit 124 thus improves occupants comfort when activating the haptic alert device 120.

Accordingly, the configuration and calibration of the actuators in the seat assembly 200 can be varied according to the user footprint 530. Such customization of the haptic alert device 120 improves user experience and safety in cases such as the vehicle 10 being used in car sharing services (e.g., MAVEN™)

Alternatively, or in addition, the configuration and calibration of the actuators is varied based on the alert that is being provided to the user. For example, additional contextual information is provided to the driver based on particular haptic feedback being provided by the actuators in the seat assembly 200 being driven, e.g. direction (left, right, etc.). For example, the actuators 322, 332, 382, 392 may individually generate various portions of a haptic alert, respectively, or be individually operated to generate the entire response. As an example, the two back actuators 382, 392 provide a clear signal regarding the nature of the alert and direction the alert is referring to, e.g., rapid pulsing of the left back actuator 382 signals to the driver that a vehicle is approaching in the left adjacent lane and/or that a vehicle is within the left-side side blind spot. Additional actuators, such as also activating the right actuator in this case of an alert associated with the left lane, may increase the chance that the occupant will incorrectly associate the activation with a right side event and it may increase the time it takes for the occupant to determine a left side event has occurred. Similarly, the position and size of the actuators 322, 332. 382, 392 provide advantages with respect to seat durability, which can be measured by commonly used sliding entry, jounce and squirm, and knee load durability seat validation tests. The actuators 322, 332. 382, 392 may be designed to function for 100,000 actuation sequences over 150,000 miles of vehicle life. Other actuator positions may compromise occupant detection and alert effectiveness, seat comfort, and seat durability. For example, if the haptic device is placed at the very front edge of the seat bottom, the occupant may not perceive seat vibrations if they pull their legs back against the front portions of the seat.

The customization of the array of actuators in the haptic alert device 120 facilitates adapting the haptic actuator intensity level to maximize driver comfort. Further yet, by detecting the user footprint 530 and customizing the actuators in the haptic alert device 120 accordingly, the vehicle 10 can ensure contact between the haptic alert device 120 and the driver.

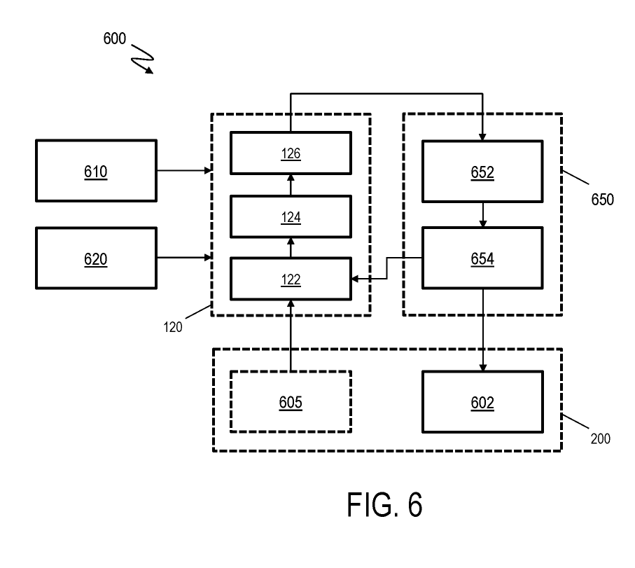

FIG. 6 depicts a block diagram of a haptic alert device customization system according to one or more embodiments. The haptic alert device customization system 600 includes, among other components, the array 500 of actuators in the seat assembly 200. The system 600 also includes one or more pressure sensors 605 that are part of the seat assembly 200 that facilitate measuring pressure applied by a driver seated on the seat assembly 200. In one or more examples, the pressure sensors are massagers embedded in the seat assembly 200.

The system 600 further includes a haptic controller 650. In one exemplary embodiment, the haptic controller 650 corresponds to the control module 130 discussed above, although the haptic controller 650 may alternatively be a separate controller. The haptic controller 650 commands the actuators 322, 332, 382, 392 based on the user footprint 530 and the alert to be provided to create the haptic feedback felt by the driver of the vehicle 10. The haptic feedback created by the haptic pulses indicates the type of alert, e.g., the nature of the collision condition. The haptic controller 650 determines the appropriate voltage and determines, for example, a pulse width modulation (PWM) pattern of “on” periods where voltage is provided to the actuators and “off” periods where no voltage is provided to the actuators.

In one or more examples, the haptic controller 650 includes and ammeter 652. Alternatively, or in addition, the ammeter 652 may be an external circuit coupled with the controller 650. The ammeter 652 measures current iₙ from each actuator in the array. The haptic controller 650 further includes a processing unit 654 that performs on or more computations, for example based on one or more computer executable instructions.

The system 600 can further include a human-machine interface (HMI) device 610 that facilitates the driver to enter one or more preferences for the user settings. For example, the HMI device 610 can include one or more buttons, touchscreen, sensors, and the like that the user can use to enter the user settings. The HMI device 610 can be the driver-vehicle interface of the vehicle 10.

The system 600 further includes one or more cameras 620 that is/are used to capture one or more images of the user to determine the user footprint 530.

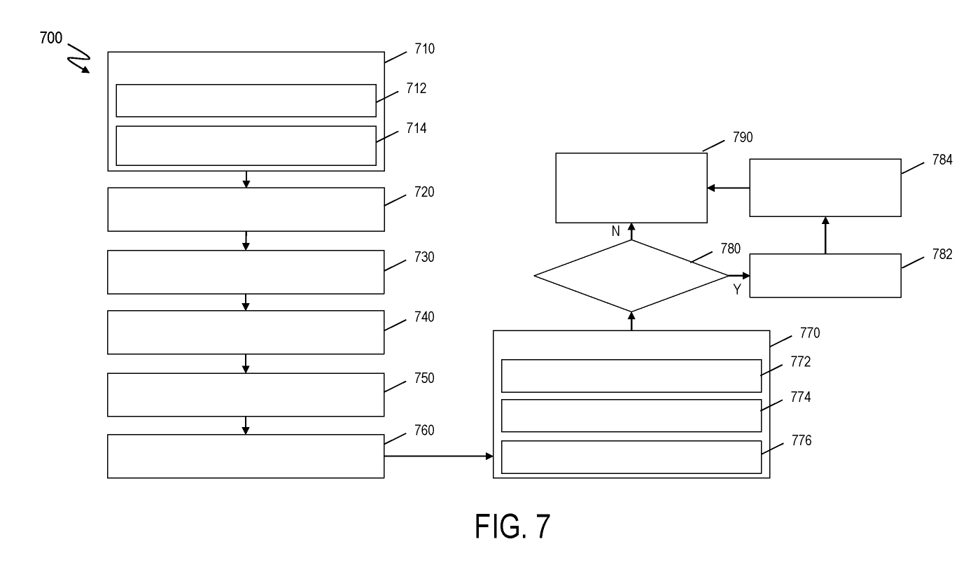

FIG. 7 depicts a flowchart for customizing a haptic alert device according to one or more embodiments. The method 700 includes estimating a force on the seat assembly 200 using the N haptic actuators in the array 500, at 710. Estimating the force includes measure an electric current iₙ from each haptic actuator in the array 500, at 712. Further, the method includes computing the force pₙ=ƒ(iₙ), for each haptic actuator in the array 500, at 714. The function ƒ(i), in one or more examples, is a parametric function (e.g. polynomial), which is a predetermined function. Alternatively, in one or more examples, the force is determined using a look-up table (LUT) that is calibrated to convert the measured current to a corresponding weight value. The current values are measured using the ammeter 652.

Further, the method 700 further includes computing an estimated weight of the driver seated on the seat assembly 200, at 720. In one or more examples, the estimation is performed by computing:

G=Σwₙpₙ+c Eq. (1)

Here, G is the estimated driver weight, wₙ are predetermined weight factors associated with each of the N haptic actuators in the array 500, and c accounts for additional weight of the driver that is not on the seat assembly 200 (e.g. legs). In one or more examples, the weight factors wₙ are parameters that are based on regression and training data that includes empirical force values pₙ. Accordingly, the weight estimate is a weighted sum of all the force estimates from the haptic array 500 on the seat assembly 200.

Alternatively, in one or more examples, the weight estimate G is computed directly using the current measurements. In this case the estimation can be performed by computing:

G=Σwₙiₙ+c Eq. (2)

Here, the weight factors wₙ are parameters that are based on regression and training data that includes empirical current values iₙ.

Further, the method 700 includes determining occupancy of the driver on the seat assembly 200, at 730. The occupancy is determined by comparing the force values for each haptic actuator in the array with corresponding threshold values Tₙ. In one or more examples, each haptic actuator from the array 500 has a different threshold value respectively, for example, the threshold value may be smaller for seat back compared to seat front. Accordingly, a haptic actuator is considered to be part of the first set of actuators 510 that is to be activated (or maintained activated) if pₙ>Tₙ; and is considered to be part of the second set of actuators 520 that is to be deactivated (or maintained deactivated) if pₙ≤Tₙ. Accordingly, the footprint 530 of the driver is determined by occupancy and positions of each haptic actuator in the array 500.

It should be noted that in one or more examples, the seat assembly 200 may contain strain gauges or other sensors to detect presence of users on the seat assembly 200. In such cases such strain gauges are used to detect occupancy of the driver. In one or more examples, such strain gauges may be limited to binary detection (occupied/unoccupied) and may be unsuitable for weight estimation.

The method 700 further includes receiving user demographic information, at 740. The demographic information can include gender, age, height, and the like. In one or more examples, the driver may provide the demographic information, for example, via the HMI 620. Alternatively, or in addition, the demographic information may be obtained automatically via the camera 610.

Further, the method 700 includes computing a haptic activation intensity I for the haptic actuators in the array 500, at 750. In one or more examples, the intensity is determined using I=g(S, W, A, H), where g is a regression function, S is sex, W is the weight, A is age, and H is height of the driver. Alternatively, the intensity is determined using a look-up table that maps the parameters S, W, A, and H, to an intensity value. In one or more examples, the computed intensity I is used across all the haptic actuators in the array 500. Alternatively, the intensity I is scaled differently for each actuator in the array 500, so that the intensities may be same for all actuators or different for each.

The method 700 further includes reconfiguring the haptic array 500, at 770. The reconfiguring includes selecting the first set of haptic actuators 510 to be activated, at 772 and the second set of haptic actuators 520 to be deactivated, at 774. The reconfiguration further includes grouping certain actuators in the array 500 to convey, for example, directional information as described herein. The grouping is performed on the first set of activated actuators 510, at 776. The grouping creates a mapping between specific haptic actuators and direction in the occupant footprint 530 that contains the currently active haptic actuators. For example, the activated actuators can be grouped such as “front->lowermost active layer on seat bottom”, “left-front->leftmost active layer on seat bottom”, and “rear->uppermost active layer on seat back”. It is understood that different, additional, or fewer groups can be formed in different examples, than those listed above.

The method 700 further includes determining if there is an overlap among the groups that prevents providing directional information, at 780. For example, the overlap may cause an insufficient number of active actuators in one group, for example if the leftmost and rightmost groups intersect. The overlap is determined if the number of common actuators in two groups is above a predetermined threshold.

If the overlap is detected, the method 700 includes providing an alert to the driver to change seating position on the seat assembly 200, at 782. In one or more examples, the alert is provided via the haptic array 500, such as by generating a haptic feedback via all the haptic actuators in the array 500. In one or more examples, the alert may use a particular pattern of haptic feedback provided by the actuators in the array 500. Further, in one or more examples, in case the overlap is detected, the method 700 includes configuring the HMI 640 to provide the alerts regarding directional information, instead of using the haptic array 500, at 784. For example, the HMI 610 can be configured to display an image representative of the vehicle 10 with an alert indicating the directional aspect of the alert, such as an image/animation on a specific side of the image representative of the vehicle 10.

The method 700 further includes calibrating the actuators in the array 500 according to computed intensity values, at 790. In one or more examples, the actuators are calibrated regardless of whether an overlap is detected or not. Alternatively, in one or more examples, the actuators are calibrated only if the overlap is not detected. In one or more examples, upon providing the alert to the driver to change his/her position, the system 600 repeats the method to determine the user footprint 530 and the actuators are calibrated once there is no overlap detected.

The method 700 is repeated periodically, for example after a predetermined time interval. Alternatively, or in addition, the method 700 is initiated when the seat position is changed. Alternatively, or in addition, the method 700 is repeated when the vehicle 10 is ignited. Alternatively, or in addition, the method 700 is initiated on demand, in response to a request via the HMI 610.

In one or more examples, the haptic alert device 120, which may be integrated with the seat assembly 200, is used to provide augmented reality features to improve the driver's spatial awareness, to further reduce safety risks and improve user experience. For example, an augmented reality system that uses the haptic alert device 120, along with other components such as the HMI 610, can reduce accidents caused by distractions, absent mindedness, and/or reckless drivers of remote vehicles. Further, the augmented reality system can facilitate improved trust, confidence, and re-engagement of the driver during transition of the vehicle 10 from an autonomous operation mode to a manual operation mode.

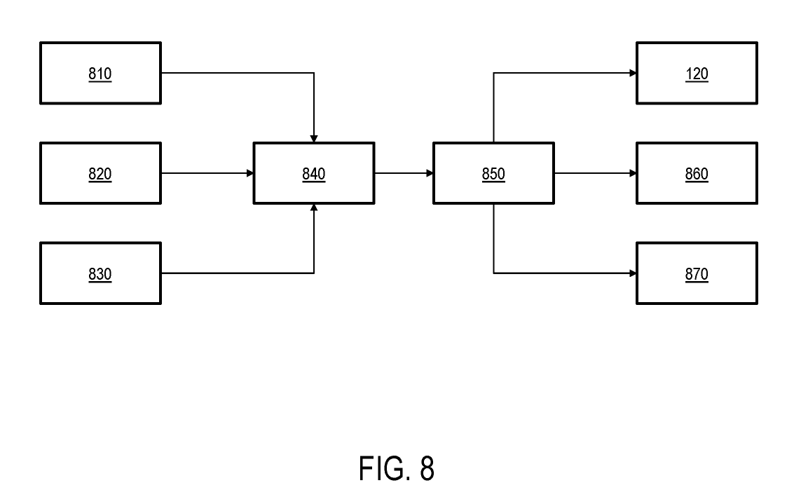

FIG. 8 depicts a block diagram for an augmented reality system for a vehicle according to one or more embodiments. The illustrated augmented reality system 800 includes a sensor fusion module 810, a driver monitoring system (DMS) 820, a remote driver monitoring system (RDMS) 830, a prioritization module 840, a mapping module 850, the haptic alert device 120, a display system 860, and an acoustic system 870, among other components.

The sensor fusion module 810 produces object tracks based on one or more on-board sensors of the vehicle 10, such as LIDAR, camera, radar, V2V, etc. that monitor objects within a predetermined surrounding/vicinity of the vehicle 10. Sensor fusion combines the sensory data or data derived from the disparate sources such that the resulting information has less uncertainty than would be possible when these sources are used individually. In one or more examples, the sensor fusion is performed on the sensory data from sensors with overlapping field of view. The result of the sensor fusion module 810 provides information about one or more objects that are in the predetermined vicinity of the vehicle 10. For example, the object information includes a distance from the vehicle 10, and a directional information indicative of a direction in which the object is in relation to the vehicle 10. The object information can also include a traveling speed of the object, and a predicted collision time when the object may collide with the object. Further, the object information can include a track of the object, which is a set of previous positions of the object, and a predicted track of the object.

The DMS 820 computes and provides a driver attentiveness level (score/rating) of the driver of vehicle 10. In one or more examples, the driver attentiveness is computed using known techniques and based on one or more sensors on board the vehicle 10 that are used to monitor the driver. For example, the one or more sensors track an eye gaze of the driver, a direction in which the driver is looking. Other types of sensors and measurements can be used to measure the driver attentiveness by the DMS 820.

The RDMS 830 monitors one or more remote vehicles (vehicles other than the vehicle 10) and provides a recklessness score of a remote vehicle based on driving characteristics of the remote vehicle. In one or more examples, the sensor fusion module 810 provides data to the RDMS 830, which uses the input data to determine the reckless score of the remote vehicle(s).

The prioritization module 840 receives the outputs from the sensor fusion module 810, the DMS 820, and the RDMS 830 to generate an alert for the driver. The alert can include highlighting one or more objects that are being tracked by the one or more on-board sensors and/or systems. For example, the prioritization module 840 determines a priority score for each object being tracked using metrics such as Time of Intercept (TOI), distance, and velocity associated with each of the object, received from the sensor fusion module 810. For example, the priority scores of the remote objects are inversely proportional to the TOI and/or distance from the vehicle 10, accordingly, giving higher priority to a remote object that is closer to the vehicle 10 or that may reach the vehicle (or vice versa) 10 earlier.

Further, the prioritization module scales the priority scores using metrics based on the output from the DMS 820. A higher scaling factor is used for objects in the direction in which the driver is not looking, e.g. higher scaling factor to an object in front of the vehicle 10 when the driver looks away. In one or more examples, the prioritization module 840 further selects the top Q objects from those being tracked based on the computed priority score. The prioritization module 840 accordingly determines which remote objects to present to the driver to prevent information overload. The prioritization is based on remote object metrics such as distance, time to intercept and speed, which can be further combined to a single score using weight factors for each metric. The weight factors can incorporate contextual information—such as driver attentiveness, driving environment (e.g. urban vs rural, highway, etc.), remote vehicle recklessness score.

The mapping module 850 maps the selected Q objects to the one or more output devices of the augmented reality system 800, namely the haptic alert device 120, the display device 860, and the acoustic system 870 to provide continuous feedback and/or alert associated with an object with the mapped output device(s). For example, the mapping module 850 maps a TOI of an object to a haptic pulse rate or intensity of the haptic alert device 120; that is, the intensity of the actuators in the array 500 is calibrated and changed according to the TOI. For example, the intensity and frequency increases as the TOI decreases. In addition, the mapping module 850 maps the TOI to a color of an object in the display device 860. For example, the object with a TOI within a particular predetermined range is displayed using a color associated with that range. Additionally, the mapping module 850 maps the TOI to an audible alert generated by the acoustic system 870. For example, if the TOI falls below a predetermined threshold, the audible alert is generated via the acoustic system 870.

The display device 860 can be a heads-up display (HUD), a touchscreen, or any other display system that provides visual feedback to the driver. In one or more examples, the display device 860 provides a 3D or a 2D projection of the objects that are being tracked by the one or more on-board sensors. The display device 860 may provide additional visual feedback such as information about one or more components of the vehicle 10. The acoustic system 870 is a system that provides audio feedback to the driver. In one or more examples, the acoustic system 870 can include one or more speakers of the vehicle 10 or any other audio feedback device.

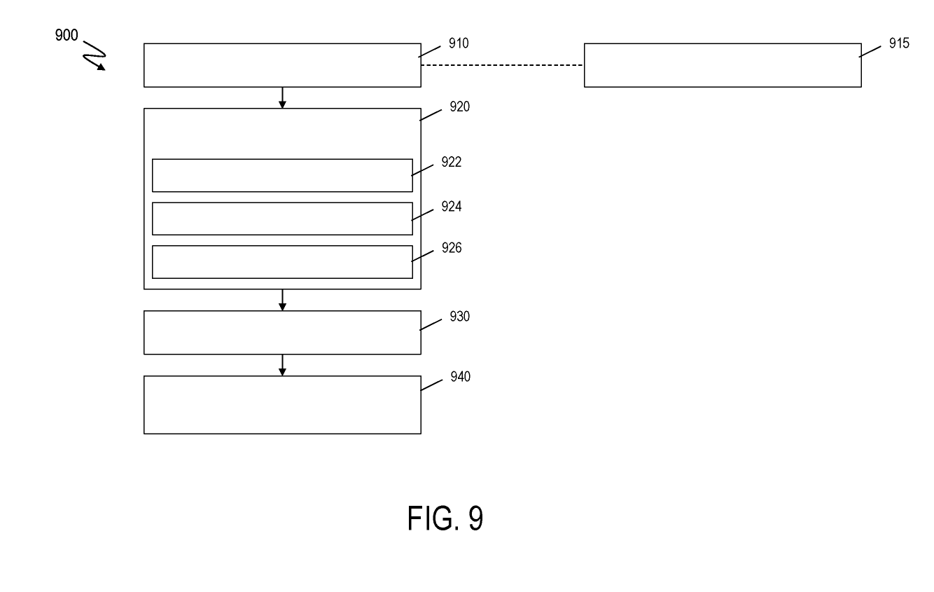

FIG. 9 depicts a flowchart for providing spatial awareness alerts to a driver via an augmented reality system according to one or more embodiments. The method 900 depicted includes computing/receiving a metric for a remote object in vicinity of the vehicle 10, at 910. The metric is determined based on the sensor fusion data by the RDMS 830. In one or more examples, the metric is a distance of the object from the vehicle 10. Alternatively, the metric is a TOI of the object with the vehicle 10. The object can be any object in a predetermined vicinity of the vehicle 10. For example, the object can be a stationary object, a pedestrian, another vehicle, and the like.

In one or more examples, the metric is a recklessness score of a remote vehicle, at 915. In one or more examples, the recklessness score is accessed from a remote server using one or more identifiers of the remote vehicle detected by the one or more sensors. For example, the recklessness score is determined using a license plate number, a vehicle identification number, and the like that the sensors capture of the remote vehicle.

Alternatively, or in addition, the recklessness score is based on monitoring one or more driving characteristics of the remote vehicle. For example, the on board sensors of the vehicle 10 monitor one or more driving characteristics of the remote vehicle and compute a recklessness score of the remote vehicle using the driving characteristics. In one or more examples, the RDMS 830 uses sensor fusion and/or V2X/wireless data to monitor driving characteristics such as speed, swerving, and lane violations of the remote vehicle. For example, the sensor fusion data provides a movement track of the remote vehicle. The RDMS 830 performs a Fourier analysis, Kalman filtering, or other analysis or a combination thereof using the movement track data of the remote vehicle to determine the one or more driving characteristics.

For example, the RDMS 830 computes a lateral variability of the remote vehicle by determining a deviation amplitude and a deviation frequency of the remote vehicle using the movement track. The movement track is a collection of position data of the remote vehicle over a predetermined amount of time. The deviation amplitude is indicative of an amount of deviation of the remote vehicle from a center of a lane in which the remote vehicle is traveling. The deviation frequency is indicative of a frequency at which the remote vehicle deviates from the center of the lane in which the remote vehicle is traveling. The lateral variability is a combination of the deviation amplitude and the deviation frequency.

Further, the RDMS 830 determines abrupt braking of the remote vehicle from the movement track data. For example, the RDMS 830 determines a maximum deceleration of the remote vehicle in a predetermined time window from the movement track data. Further, the RDMS 830 determines a deviation from a speed limit by the remote vehicle. The RDMS 830 computes the recklessness score of the remote vehicle using one or more of these driving characteristics. For example, the RDMS 830 uses exponentially moving average to reduce each of the driving characteristics to a single value and computes the recklessness score as a predetermined function of the reduced values. Alternatively, the recklessness score can be determined using a lookup table with the reduced values.

It should be noted that the recklessness score may be determined using other driving characteristics in other examples. Further, it should be noted that while an example of the recklessness score is described herein, in other examples other metrics of the remote vehicle (and other objects) are computed.

The method 900 further includes mapping the computed metric to the augmented reality system 800, at 920. As described herein, the mapping includes determining one or more customization parameters for the one or more output devices of the augmented reality system 800. For example, the mapping module 850 determines an intensity/pulse rate and/or frequency of the haptic alert device 120, a color for the object in the display device 860, and an audible alert for the object in the acoustic system 870 based on the computed metric, at 922, 924, and 926. In one or more examples, the mapping includes determining the parameters for the output devices using corresponding look up tables. Alternatively, or in addition, the parameters are determined using a predetermined formula that uses the computed metric as an input value. It should be noted that the mapping is performed if the prioritization module 840 indicates that the object is one of the Q objects that the driver is to be alerted about based on the computed metric.

The method further includes customizing the augmented reality system 800 according to the mapping for the computed metric, at 930. The customization is performed to provide the driver a spatial awareness of the object. For example, the customization includes configuring and calibrating the one or more actuators in the haptic alert device 120 as described herein.

Further, the calibration can include adjusting the output of the display device 860 by changing the color/size, or any other attribute or a combination thereof of a representation of the object, for example to indicate an intensity/urgency of the computed metric. The display can also be customized to provide a directional information of the object. Further yet, the calibration can include adjusting the audio output of the acoustic system 870 to indicate the metric including the intensity/urgency and the directional information. For example, the audio output provides a directional audio, such as by using one or more speakers on a specific side of the driver to indicate a direction of the object and a specific pattern/tone/audible/volume to indicate the urgency of the metric.

The method 900 further includes providing the spatial awareness alert to the driver that includes directional information of the remote object and an intensity of the computed metric via the augmented reality system 800, at 940. Providing the alert includes causing one or more of the haptic alert device 120, the display device, 860, and the acoustic system 870, to generate an output using the customizations.

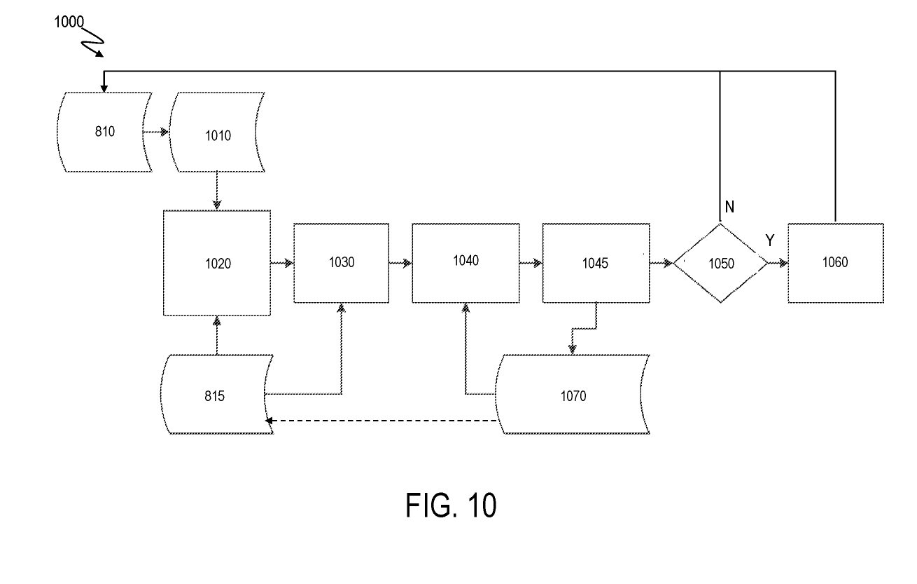

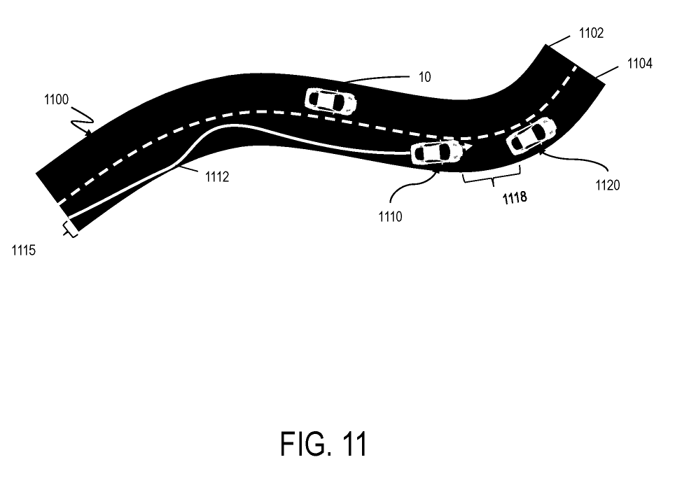

FIG. 10 depicts an operational flow diagram for a method for monitoring a remote vehicle and determining the recklessness score for the remote vehicle. The depicted flow diagram is further described in view of an example scenario depicted in FIG. 11. In the example scenario the vehicle 10 is traveling along a road segment 1100 in a first lane 1102 with a first remote vehicle 1110 and a second remote vehicle 1120 traveling within a monitoring vicinity of the vehicle 10. The first remote vehicle 1110 and the second remote vehicle 1120 are shown to be traveling in a second lane 1104. It is understood that the depicted scenario is exemplary and that various other scenarios are possible.

Referring to FIG. 10, the method 1000, which can be performed by the RDMS 850, includes obtaining a remote vehicle track 1112 for the remote vehicle 1110 in the vicinity of the vehicle 10, at 1010. The remote vehicle track 1112 is generated from the data obtained from the sensor fusion module 810. For example, the RDMS 850 keeps track of a sequence of attributes such as identifiers, positions, velocities, etc. for the remote vehicle 1110. The attributes can be detected using one or more of the onboard sensors, such as lidar, radar, camera, GPS, and the like. In addition, the RDMS 850 can receive the attributes of the remote vehicle 1110 using vehicle-to-vehicle communication with the remote vehicle 1110. It should be noted that the RDMS 850 performs the method 1000 for each of the remote vehicles in vicinity of the vehicle 10.

The method 1000 further includes determining lane center and lateral position of the remote vehicle 1110 in the lane 1104, at 1020. The RDMS 850 uses map/lane sensing for determining the lane-position of the remote vehicle 1110. The map information is obtained from a storage device, which may be local or remote. The lane sensing is performed using the on board sensors, sensor fusion module 810, and the like, or a combination thereof, and is known in the art. Determining the lane center and lateral position of the remote vehicle 1110 in the lane 1104 further includes converting the remote vehicle track data into a lane-centric coordinate space relative to the vehicle 10.

The method 1000 further includes extracting a set of features from the remote vehicle track 1112, at 1030. A “feature” is a quantified driving characteristic of the remote vehicle 1110 based on monitoring the remote vehicle track 1112 in relation to the driving conditions and environment. For example, the driving conditions and environment include speed limit, traffic signs, traffic lights, and other such factors that affect drivability of the road segment 1100. Such driving conditions are detected by the on board sensors and/or are available to the RDMS 850 via the map information.

The extracted features include the lateral variability of the remote vehicle 1110. In one or more examples, the lateral variability is computed as the Fractional power in lateral deviation time-series:

$$e = \frac{P ( {x}^{HP} )}{P ( x )} ,$$

where x^{HP} is determined by high-pass filtering the lateral position time series x with a predetermined cut-off frequency f_{c}. The lateral position time series x includes a position of the remote vehicle 1110 with respect to the center of the lane 1104 in which the remote vehicle 1110 is traveling. In other words, the position time series is a series of lateral deviations 1115 of the remote vehicle 1110. The function P is the square of the lateral position x averaged over a time window, e.g. P(xₙ)=Σ_{i=n-N}ⁿxₙ² for a time window of N prior samples. The time-series includes a predetermined number of observations of the remote vehicle 1110; alternatively, or in addition, the time-series includes a number of observations recorded over a predetermined time window.

Alternatively, or in addition, the lateral variability is computed as a variance of yaw rate of the remote vehicle 1110 within the predetermined time window. The yaw rate is computed based on the lateral deviation 1115 of the remote vehicle 1110.

The extracted features can further include a measure for abrupt braking of the remote vehicle 1110 in the predetermined time window. As described earlier, the abrupt braking is computed by determining a maximum deceleration within the predetermined time window.

Further yet, the extracted features include a number of speed violations by the remote vehicle 1110. The number of speed violations by the remote vehicle 1110 are monitored based on comparing the speed of the remote vehicle 1110 with a known speed limit along the road segment 1100. Along with a frequency of speed violations, the RDMS 850 also monitors an amplitude of the speed violations by keeping track of how much the remote vehicle 1110 deviates from the speed limit.

The extracted features can further include a number of road sign/signal violations within the predetermined time window, such as a stop sign violation, a speed limit violation, and the like.

The extracted features can further include a number of lane changes by the remote vehicle 1110 within the predetermined time window. Further yet, the extracted features includes a tailgating distance 1118 measure of the remote vehicle 1110. The tailgating distance 1118, in one or more examples, is an average distance between the remote vehicle 1110 and a lead vehicle (second remote vehicle 1120) over the predetermined time window.

Further yet, the extracted features can include a lane marking departure of the remote vehicle 1110. The lane marking departure is measured by monitoring a signed distance to lane edge of the remote vehicle 1110 over the predetermined time window. A number of times the remote vehicle 1110 crosses a lane marking is monitored and used to determine a recklessness score for the remote vehicle 1110. In one or more examples, the remote vehicle 1110 is determined to have crossed the lane marking if the signed distance to the lane edge exceeds a predetermined threshold.

Referring again to FIG. 10, the method 1000 further includes computing a “recklessness” score 1045 of the remote vehicle 1110 using the extracted features, at 1030. The recklessness score can also be referred to as a “safety score” of the remote vehicle 1110. In one or more examples, the recklessness score is a probability value in the range (0-1).

In one or more examples, the recklessness score is computed using machine learning using labelled training data. In this case, a classifier is trained using a set of feature vectors and corresponding hand labelled “recklessness” values (0/1) that are available. For example, the classifier is trained using logistic regression where

$$recklessness score = \frac{1}{1 + {e}^{- b \cdot x}}$$

for feature vector x and weights b, the weights being assigned to the different feature vectors and x is the set of features. It should be noted that in other examples, the machine learning can use neural networks, support vector machine, or any other machine learning algorithm. By evaluating the classifier with feature vector directly gives score as a class probability for the remote vehicle 1110.

The weights b can be stored in a memory device that is local to the RDMS 850 or is a remote server accessible by the RDMS 850. In one or more examples, the machine learning algorithm that is used by the classifier to compute the recklessness score is stored in the memory device 815. The machine learning algorithm, such as one or more coefficients, weights, and the like, are updated continuously.

Alternatively, the classifier determines the recklessness score 1045 using a classifier that is trained without labelled data. For example, in this case the classifier is trained using feature vectors that primarily include safe driving behaviors, for example, that result in recklessness score below a predetermined value such as 0.3, 0.25, or the like. Recklessness scores greater than the predetermined value may be considered reckless. The classifier is trained using a robust method to reject effects of reckless driving in training data, such as using known training techniques like RANSAC. The classifier can use any models like, linear regression, generalized Linear Model (GLM), etc. It should be noted that in case of the non-labelled training data the recklessness score is computed as 1−p-value of trained model evaluated with feature vector.

The interpretation of the recklessness score computed using a classifier with labelled data versus a classifier with non-labelled data can be different. Accordingly, thresholds used in the two cases to determine which recklessness scores are indicative of a reckless remote vehicle can be different. The recklessness score 1045 is compared with a predetermined threshold value, which is based on the type of classifier used, at 1050 (FIG. 10). If the recklessness score is less than (or equal to) the predetermined threshold value, the driver is not alerted about the remote vehicle 1110, and the method 1000 continues to operate. In one or more examples, the method 1000 may analyze the second remote vehicle 1120 in the next iteration.

Alternatively, if the recklessness score is above the predetermined threshold, the method 1000 includes generating and providing an alert about the remote vehicle 1110 to the driver, at 1060. The alert can include a spatial awareness alert that is includes a directional information of the location of the remote vehicle 1110 to the driver along with an intensity of the alert being based on the recklessness score that is computed. The mapping of the recklessness score is performed as described herein. The alert can be provided via the haptic alert device 120, the display device 860, and/or the acoustic system 870 that are part of the augmented reality system 800. In one or more examples, the remote vehicle 1110 may be highlighted in the display device 860 along with directional information being provided via the haptic alert device 120 and/or the acoustic system 870.

Further, the method 1000 includes updating a stored recklessness score 1045 of the remote vehicle 1110 in the memory device 815, at 1070. For example, the recklessness score 1045 of the remote vehicle 1110 is stored in the memory device 815. The recklessness score 1045 is stored mapped with one or more identifiers of the remote vehicle 1110, for example, license plate number, barcode, or any other identifier associated with the remote vehicle 1110. The stored recklessness score 1045 is used for future access. For example, if the remote vehicle 1110 is observed in the vicinity of the vehicle 10 at a future time (e.g. next day, week, month, or the like), the recklessness score 1045 of the remote vehicle 1110 can be accessed from the memory device 815 and an alert can be generated. Further, the recklessness score 1045 can be provided to third parties, such as to other vehicles, insurance providers, highway patrol agencies, and the like, in one or more examples. The stored recklessness score can also be used as a prior estimated score when computing the recklessness score 1045.

Updating the stored recklessness score for the remote vehicle 1110 depends on how the recklessness score 1045 is computed, for example, with or without the labelled data. In case the recklessness score 1045 is computed using a classifier that is trained using a labelled dataset, the stored recklessness score for the remote vehicle 1110 is updated using Bayes rule, in one or more examples. Accordingly,

$$p ( class \vert measure ) = \frac{p ( measure \vert class ) \cdot p ( class )}{p ( measure )} ,$$

where measure is the presently computed recklessness score 1045, and class is the previously stored recklessness score fir the remote vehicle 1110 that is stored in the memory device 815. The updated recklessness score is then stored in the memory device 815 for future use and updating.

Further, in case the recklessness score 1045 is computed using a classifier that is trained using a non-labelled dataset, the recklessness score 1045 is represented as likelihood (density) of the generated model. Accordingly, in this case the updating can use a weighted average between the presently computed recklessness score 1045 and the previous recklessness score of the remote vehicle 1110 from the memory device 815. That is, score_{new}=score_{old}·w+score_{new}·(1−w), where 0≤w≤1. Here, w is a weight factor that is a predetermined value to weight the presently computed recklessness score 1045 and the previous recklessness score.

It is understood that the above techniques of updating the stored recklessness score for the remote vehicle 1110 are just two possible examples and that in other embodiments, the update may be performed using different techniques.

The technical solutions described herein facilitate increasing driver spatial awareness using augmented reality. The technical solutions described herein provide improvements to augmented reality systems by providing spatial awareness via one or more output devices including haptic alert devices, visual output devices, and acoustic devices. In one or more examples, the alert provides location of nearby objects, such as people, vehicles, mapped to intensity of different haptic actuators in an array. The technical solutions further facilitate a remote driver monitoring system to assign a score to remote objects based on features derived from sensor fusion tracks and map information, which can be utilized by a prioritization system to customize the augmented reality system according to assigned scores. Further, the technical solutions described herein facilitate remote object mapping to haptic array, display, and/or acoustics to communicate to driver positions and importance of one or more remote objects.

Further, the technical solutions described herein facilitate a monitoring driving characteristics of remote vehicles to ascertain a recklessness score for each, using onboard-vehicle sensors. Accordingly, remote vehicles are assigned a recklessness score such as in the range (0-1), which may be used as a trigger or a prioritization mechanism for other safety features (e.g. increasing following distance) or to notify the driver of a vehicle of a reckless remote vehicle. Further, the technical solutions described herein also facilitate the computed recklessness scores to be associated with vehicle identifiers, such as vehicle registrations, and to be stored/updated in the cloud and use for future encounters with the remote vehicles. The technical solutions described herein, accordingly, improve vehicle safety and provide an input for other safety features such as an augmented reality system of the vehicle.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

1. A system for driver notification in a vehicle, the system comprising:
one or more sensors that measure one or more attributes of a remote object in a predetermined vicinity of the vehicle, the one or more attributes of the remote object comprising a time of interception between the vehicle and the remote object, the time of interception being based on a speed of the remote object and a distance between the vehicle and the remote object;
an output device that provides a notification to a driver; and
a remote object monitoring system that generates a driver notification to be provided via the output device based on the attributes of the remote object, the generation of the driver notification comprises:
determining a recklessness score for the remote object based on the attributes of the remote object; and
in response to the recklessness score exceeding a predetermined threshold, generating the driver notification that comprises a directional information that provides a spatial awareness of a location of the remote object in relation to the vehicle.

2. The system of claim 1, wherein the remote object is prioritized from a plurality of remote objects.

3. The system of claim 1, wherein the driver notification is an augmented reality notification comprising a haptic notification, a visual notification, and an audible notification, and wherein the haptic notification provides the directional information using haptic actuators from a specific section of a haptic alert device.

4. The system of claim 3, wherein:
the visual notification changes a color of the remote object in response to the recklessness score exceeding the predetermined threshold; and
the audible notification provides the directional information using speakers from a specific section.

5. The system of claim 1, wherein determining the recklessness score comprises:
receiving a prior recklessness score of the remote object based on an identification of the remote object; and
updating the prior recklessness score using the attributes of the remote object received from the one or more sensors.

6. The system of claim 5, wherein the updated recklessness score for the remote object is stored to be accessed by a second vehicle.

7. The system of claim 1, wherein the attributes of the remote object include a lateral variability of the remote object that is determined based on a deviation of the remote object within a lane of a road along which the remote object is traveling.

8. The system of claim 1, wherein the attributes of the remote object include abrupt braking by the remote object that is determined based on a maximum deceleration of the remote object within a predetermined time window.

9. The system of claim 1, wherein the attributes of the remote object include a number of lane changes by the remote object within a predetermined time window.

10. The system of claim 1, wherein the attributes of the remote object include a tailgating distance determined for the remote object with respect to a second remote object.

11. The system of claim 1, wherein the attributes of the remote object include a number of traffic sign violations by the remote object within a predetermined window.

12. A method for providing driver notification in a vehicle, the method comprising:
measuring, by one or more sensors, attributes of a remote object in a predetermined vicinity of the vehicle, the one or more attributes of the remote object comprising a time of interception between the vehicle and the remote object, the time of interception being based on a speed of the remote object and a distance between the vehicle and the remote object;
determining, by a controller, a recklessness score for the remote object based on the attributes of the remote object;
in response to the recklessness score exceeding a predetermined threshold, generating, by the controller, the driver notification that comprises a directional information that provides a spatial awareness of a location of the remote object in relation to the vehicle; and
providing, by an output device, the notification to a driver.

13. The method of claim 12, wherein determining the recklessness score comprises:
receiving a prior recklessness score of the remote object based on an identification of the remote object; and
updating the prior recklessness score using the attributes of the remote object received from the one or more sensors.

14. The method of claim 12, wherein the remote object is a plurality of remote objects and the method further comprises prioritizing a plurality of recklessness scores of the respective remote objects.

15. The method of claim 13, wherein the attributes of the remote object comprise:
a lateral variability of the remote object that is determined based on a deviation of the remote object within a lane of a road along which the remote object is traveling; and
an abrupt braking by the remote object that is determined based on a maximum deceleration of the remote object within a predetermined time window.

16. A computer program product comprising computer storage device having computer executable instructions stored therein, the computer executable instructions when executed by a processing unit cause the processing unit to provide a driver notification in a vehicle, providing the driver notification comprises:
measuring, using one or more sensors, attributes of a remote object in a predetermined vicinity of the vehicle, the one or more attributes of the remote object comprising a time of interception between the vehicle and the remote object, the time of interception being based on a speed of the remote object and a distance between the vehicle and the remote object;
determining a recklessness score for the remote object based on the attributes of the remote object;
in response to the recklessness score exceeding a predetermined threshold, generating the driver notification that comprises a directional information that provides a spatial awareness of a location of the remote object in relation to the vehicle; and
generating, using an output device, the notification for a driver.

17. (canceled)

18. The computer program product of claim 16, wherein the remote object is a plurality of remote objects and providing the driver notification further comprises prioritizing a plurality of recklessness scores of the respective remote objects.

19. (canceled)

20. The computer program product of claim 16, wherein the driver notification is an augmented reality notification comprising a haptic notification, a visual notification, and an audible notification.

21. The system of claim 1, wherein the driver notification is provided by the output device at an intensity and frequency associated with the time of interception of the attributes of the remote object.

22. The system of claim 21, wherein the intensity and frequency of the driver notification increases as the time of interception decreases.
